(19) United States
(12) Patent Application Publication
(10) Pub. No.: US 2016/0100235 A1
(43) Pub. Date: Apr. 7, 2016

(54) ELECTRONIC DEVICE WITH LOW FREQUENCY AUDIO OUTPUT CAPABILITY

(71) Applicant: HON HAI PRECISION INDUSTRY CO., LTD., New Taipei (TW)

(72) Inventors: CHANG-DA HO, New Taipei (TW); TING-YI LIAO, New Taipei (TW); YI-CHENG LIN, New Taipei (TW); JEN-TSORNG CHANG, New Taipei (TW)

(21) Appl. No.: 14/699,537

(22) Filed: Apr. 29, 2015

(30) Foreign Application Priority Data
Oct. 7, 2014 (CN) 201410519080.1

(51) Int. Cl. H04R 1/02

(52) U.S. Cl. CPC H04R 1/025

(57) ABSTRACT

An electronic device capable of outputting low frequency sound includes a hollow housing, and a speaker assembly, a first securing member, a second securing member secured to the second securing member, and a vibration plate received in the housing. The vibration plate is secured to the first securing member. The speaker assembly is secured to the second securing member, and includes a speaker and a buffer secured to the speaker. A side of the buffer away from the speaker is in contact with the vibration plate and imparts the vibration required for audio output to the vibration plate.

### FIELD

The subject matter herein generally relates to small-scale audio reproduction.

### BACKGROUND

Electronic devices, such as smart phones and tablet computers, employ speakers to generate sound. A typical speaker is an energy transducer that transforms an electrical signal to mechanical vibration. Then, the ambient air around the speaker is vibrated to generate sound.

### BRIEF DESCRIPTION OF THE DRAWINGS

Implementations of the present technology will now be described, by way of example only, with reference to the attached figures.

FIG. 1 is an isometric view of an embodiment of an electronic device.

FIG. 2 is an isometric view of an embodiment of a vibration plate and at least one speaker assembly contacting the vibration plate included in the electronic device of FIG. 1.

FIG. 3 is similar to FIG. 1, but showing the vibration plate and the at least one speaker assembly from another different angle.

FIG. 4 is an exploded, isometric view of the vibration plate and the at least one speaker assembly of FIG. 2.

FIG. 5 is an exploded view of each of the at least one speaker assembly of FIGS. 2-4.

FIG. 6 is an isometric view of another embodiment of the vibration plate and the at least one speaker assembly contacting the vibration plate included in the electronic device of FIG. 1.

FIG. 7 is an exploded, isometric view of the vibration plate and the at least one speaker assembly of FIG. 6.

FIG. 8 is similar to FIG. 7, but viewed from another angle.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “substantially” is defined to be essentially conforming to the particular dimension, shape, or other feature that the term modifies, such that the component need not be exact. For example, “substantially cylindrical” means that the object resembles a cylinder, but can have one or more deviations from a true cylinder. The term “comprising,” when utilized, means “including, but not necessarily limited to”; it specifically indicates open-ended inclusion or membership in the so-described combination, group, series and the like.

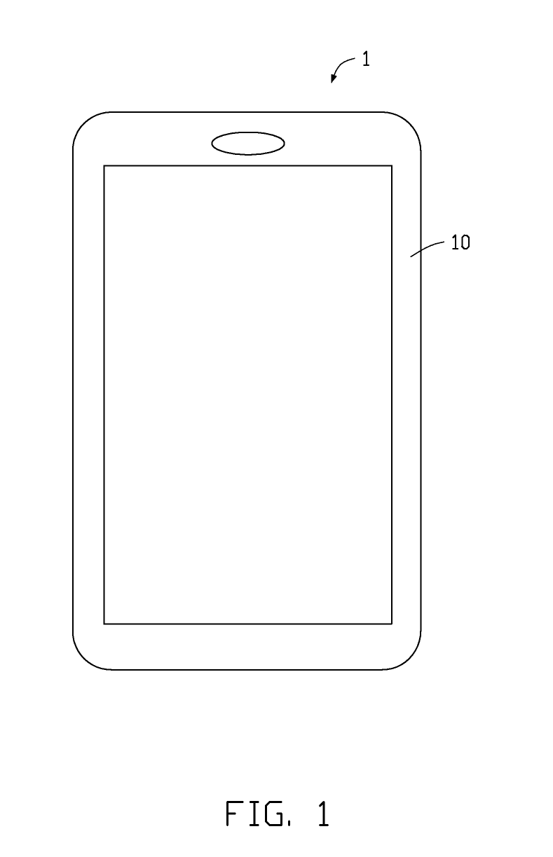

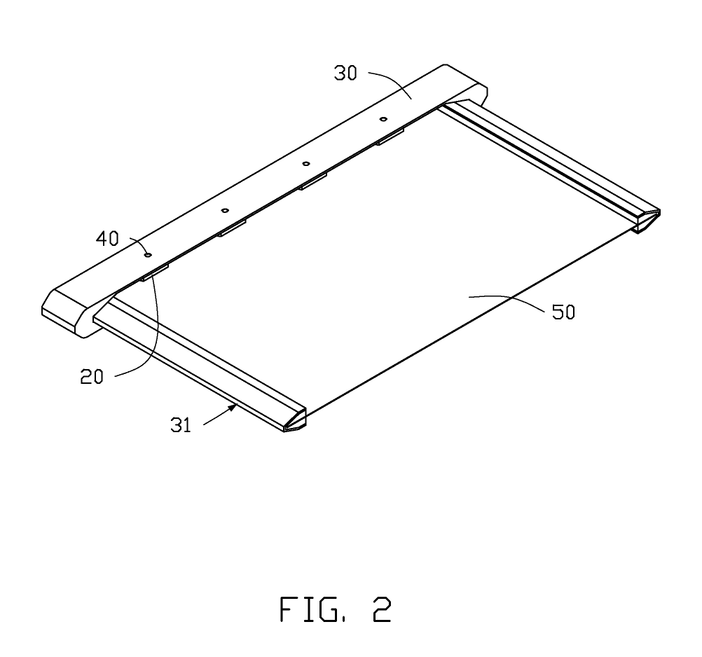

FIG. 1 illustrates an embodiment of an electronic device 1 with low frequency audio output capability. Also referring to FIG. 2, The electronic device 1 comprises a hollow housing 10, at least one speaker assembly 20, a first securing member 31, a second securing member 30, and a vibration plate 50. The speaker assembly 20, the first securing member 31, the second securing member 30, and the vibration plate 50 are received in the housing 10. The electronic device 1 can be a smart phone, a tablet computer, or a multimedia player.

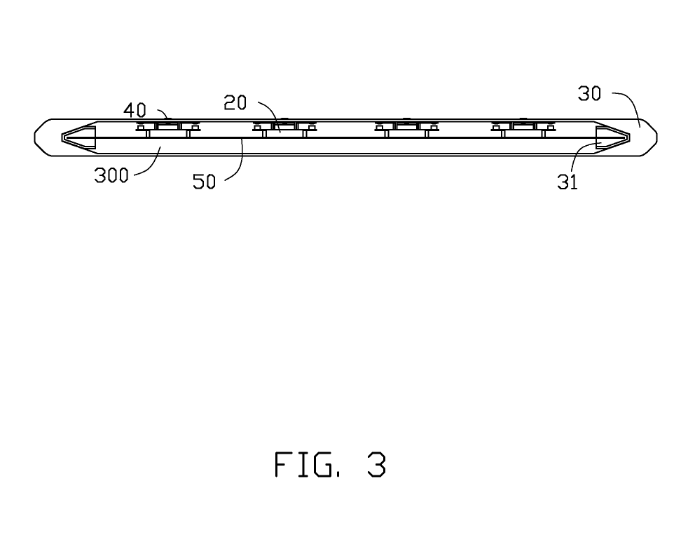

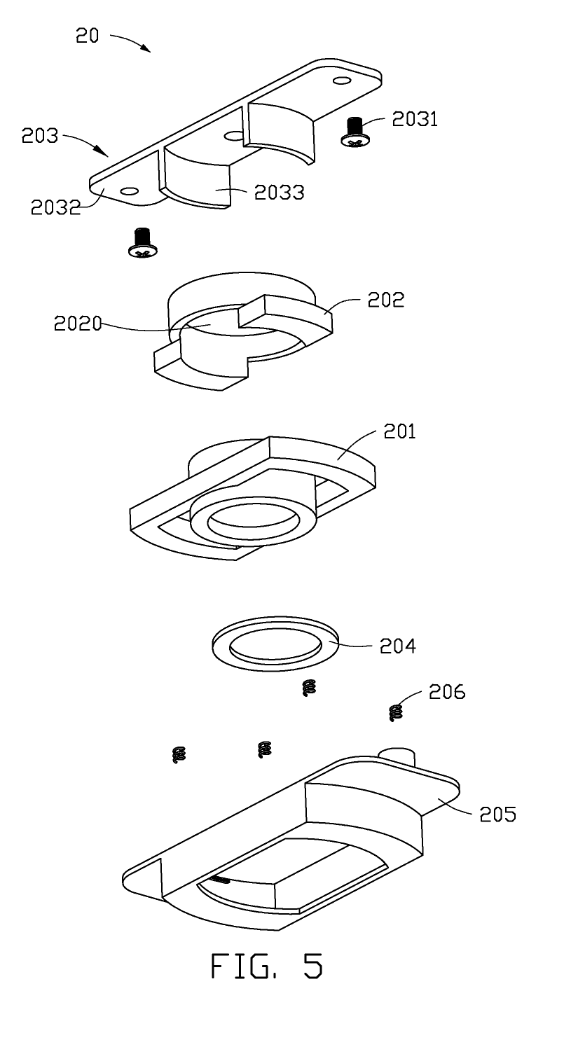

The first securing member 31 is secured to the second securing member 30. Also referring to FIG. 3, the vibration plate 50 can be substantially rectangular, and can be made of glass or metal. The vibration plate 50 is secured to the first securing member 31. Each speaker assembly 20 is secured to the second securing member 30, and includes a speaker 201 and a buffer 204 (shown in FIG. 5) secured to the speaker 201. The buffer 204 is made of a flexible material, such as foam. A side of the buffer 204 away from the speaker 201 is in contact with the vibration plate 50. As such, when the speaker 201 transforms an electrical signal to mechanical vibration to push the ambient air around the speaker 201 to generate sound, the speaker 201 imparts the vibration required for audio output to the vibration plate 50. Thus, the vibration plate 50 which is in contact with the speaker 201 via the buffer 201 can also vibrate to output sound. Therefore, the output quality of low frequency sound is improved.

Referring to FIG. 5, in at least one embodiment, each speaker assembly 20 further includes a mounting member 202 and a cover 203. The mounting member 202 is located between and secured to the speaker 201 and the cover 203. The buffer 204 is secured to a surface of the speaker 201 away from the mounting member 202. Each speaker assembly 20 is secured to the second securing member 30 via the cover 203. In at least one embodiment, the cover 203 includes a substantially flat main body 2032 and two clamping arms 2033 extending from a surface of the main body 2032. The mounting member 202 is clamped between the two clamping arms 2033, and defines a receiving opening 2020 to receive the speaker 201. The cover 203 further includes two fastening members 2031, such as flat-head screws. The main body 2032 is secured to the second securing member 30 via the fastening members 2031, thereby securing the speaker assembly 20 to the second securing member 30. In another embodiment, the fastening members 2031 can be omitted, and the main body 2032 is secured to the second securing member 31 by glue for example.

In at least one embodiment, the second securing member 30 includes at least one urging element 40. Each urging element 40 can be inserted through the second securing member 30 and the cover 203, and applies a pushing force to one speaker 201 via the mounting member 202, to cause the speaker 201 and the buffer 204 to be always in tight contact with the vibration plate 50. The urging element 40 can be a flat-head screw.

In at least one embodiment, the speaker assembly 20 further includes a supporting base 205 and a number of elastic elements 206 such as coiled springs. The supporting base 205 is elastically connected to the speaker 201 via the elastic elements 206. When the speaker 201 and the buffer 204 are in tight contact with the vibration plate 50, the elastic elements 206 are elastically deformed. When the urging element 40 is pulled away from the second securing member 30 by a user, the elastic elements 206 rebound to push the speaker 201 away from the vibration plate 50, thereby loosening the buffer 204 with respect to the vibration plate 50.

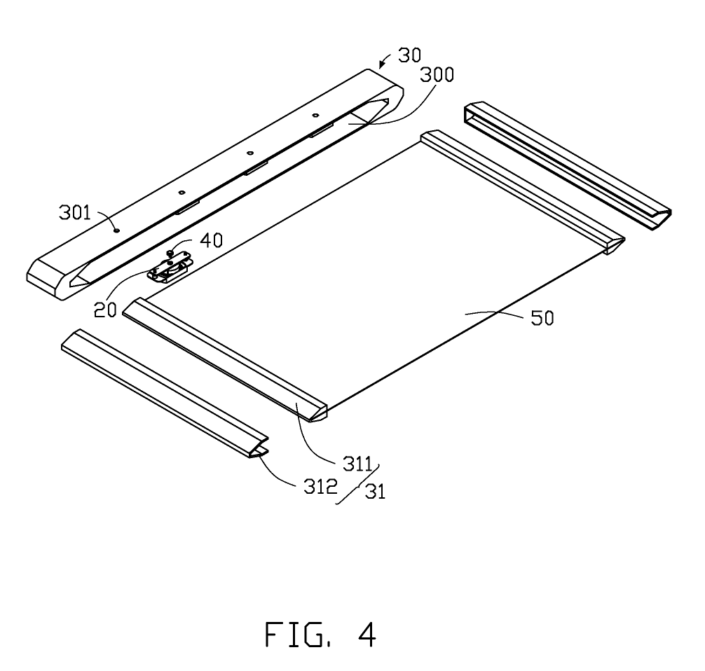

Also referring to FIG. 4, in at least one embodiment, the second securing member 30 defines an elongated slot 300. The first securing member 31 includes two pairs of clamping elements 310. The two pairs of clamping elements 310 are secured to two opposite ends of the slot 300, thereby securing the second securing member 30 to the first securing member 31. Each speaker assembly 20 is secured to the interior wall of the slot 300. The two pairs of clamping elements 310 clamp two edges of the vibration plate 50, thereby securing the vibration plate 50 to the first securing member 31. In at least one embodiment, each pair of clamping elements 310 includes a first portion 311 and a second portion 312 which wraps the first portion 311. The two second portions 312 are secured to the two ends of the slot 300, and the two first portions 311 clamp two edges of the vibration plate 50. The second securing member 30 defines at least one through hole 301 (shown in FIG. 4) communicating with the slot 300 and facing one speaker assembly 20. Each urging element 40 is inserted through one through hole 301 and the cover 203 of the speaker assembly 20, and applies a pushing force to the speaker 201 via the mounting member 202.

In another embodiment, the second securing member 30 is omitted. In this embodiment, each speaker assembly 20 and the first securing member 31 are fixedly received in the housing 10 by any manner which ensures that the buffer 204 away from the speaker 201 is in contact with the vibration plate 50. In this case, each speaker assembly 20 and the first securing member 31 can be directly fixed to the housing 10.

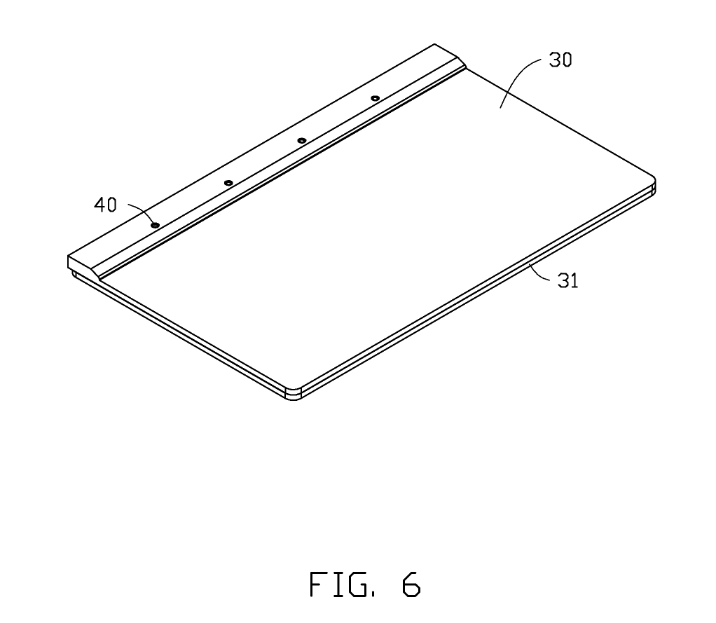

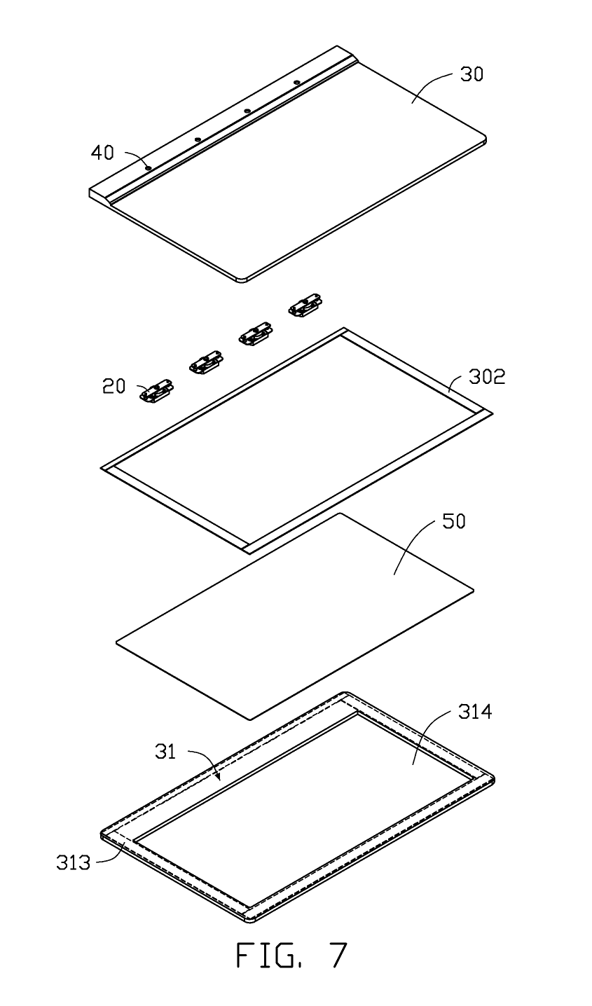

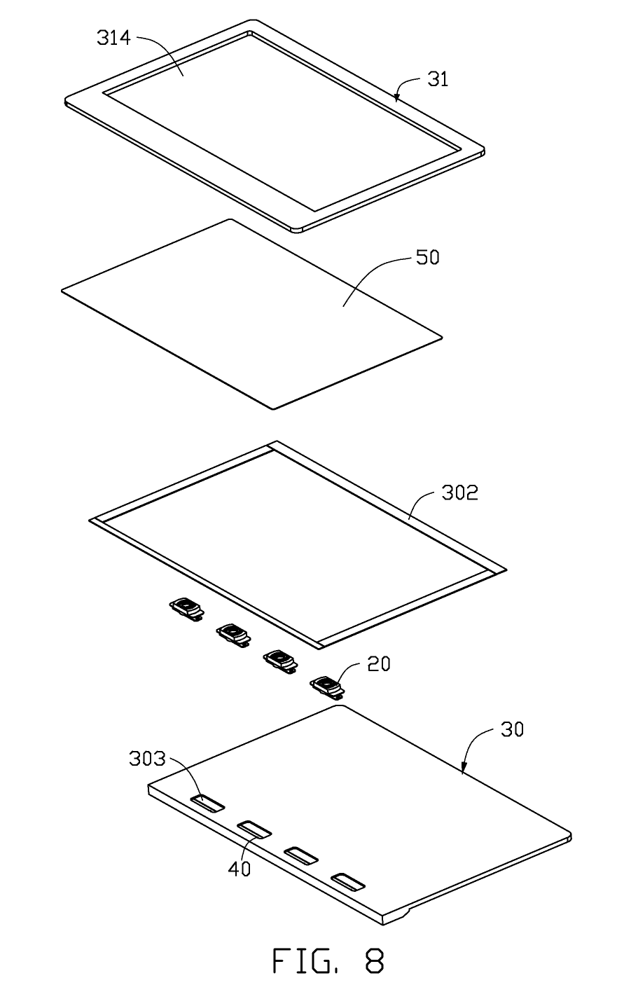

Referring to FIG. 6, in another embodiment, the second securing member 30 can be secured to the first securing member 31 by a magnetic attractive force therebetween. Also referring to FIG. 7, the second securing member 30 defines at least one receiving space 303 (shown in FIG. 8). Each speaker assembly 20 is secured in one receiving space 303, with the buffer 204 protruding out of the receiving space 303. The second securing member 30 includes a number of elongated magnets 302 along and fixed to four edges of the second securing member 30. The first securing member 31 includes a number of elongated magnets 313 along and fixed to four edges of the first securing member 31. The vibration plate 50 is located between the first securing member 31 and the second securing member 30, and is surrounded by the magnets 302. When the second securing member 30 is secured to the first securing member 31 by the magnetic attractive force between the magnets 302, 313, the vibration plate 50 is secured between the first securing member 31 and the second securing member 30. The buffer 204 protruding out of the receiving space is in tight contact with the vibration plate 50. Furthermore, each urging element 40 is inserted through the receiving space 303 and the cover 203 of one speaker assembly 20, to apply a pushing force to the speaker 201 via the mounting member 202.

The shape and structure of the first securing member 31 and the second securing member 30 can be varied. In this embodiment, the first securing member 31 and the second securing member 30 respectively function as a top cover and a bottom cover of the electronic device 1, and are secured to each other to form the housing 10. The vibration plate 50 can be a display screen of the electronic device 1. The first securing member 31 further defines a display window 314. With the above configuration, the display screen is secured between the top cover and the bottom cover of the electronic device 1, and a user can view contents displayed on the display screen from the display window 314 of the first securing member 31.

Even though information and advantages of the present embodiments have been set forth in the foregoing description, together with details of the structures and functions of the present embodiments, the disclosure is illustrative only; changes may be made in detail, especially in matters of shape, size, and arrangement of parts within the principles of the present embodiments to the full extent indicated by the plain meaning of the terms in which the appended claims are expressed.

What is claimed is:

1. An electronic device comprising:
a hollow housing;
a first securing member received in the housing;
a second securing member received in the housing and secured to the first securing member;
a vibration plate received in the housing and secured to the first securing member; and
at least one speaker assembly each received in the housing, secured to the second securing member, and comprising a speaker and a buffer secured to the speaker, a side of each buffer away from the speaker being in contact with the vibration plate.

2. The electronic device of claim 1, wherein each speaker assembly further comprises a mounting member and a cover; the mounting member is located between and secured to the speaker and the cover; the buffer is secured to a surface of the speaker away from the mounting member; each speaker assembly is secured to the second securing member via the cover.

3. The electronic device of claim 2, wherein the cover comprises a substantially flat main body and two clamping arms extending from a surface of the main body; the mounting member is clamped between the two clamping arms, and defines a receiving opening to receive the speaker.

4. The electronic device of claim 3, wherein the main body further comprises two fastening members; the main body is secured to the second securing member via the fastening members, thereby securing the speaker assembly to the second securing member.

5. The electronic device of claim 2, wherein each speaker assembly further comprises a supporting base and a plurality of elastic elements; the supporting base is elastically connected to the speaker via the elastic elements; the elastic elements are elastically deformed when the speaker and the buffer are in tight contact with the vibration plate, and rebound to push the speaker away from the vibration plate when the urging element is pulled away from the second securing member, thereby loosening the speaker and the buffer with respect to the vibration plate.

6. The electronic device of claim 2, wherein the second securing member comprises at least one urging element; each urging element is inserted through the second securing member and the cover of one speaker assembly, and applies a pushing force to one speaker via the mounting member to cause the speaker and the buffer to be always in tight contact with the vibration plate.

7. The electronic device of claim 6, wherein the second securing member defines an elongated slot; the first securing member comprises two pairs of clamping elements; the two pairs of clamping elements are secured to two opposite ends of the slot, thereby securing the second securing member to the first securing member; each speaker assembly is secured to an interior wall of the slot; the two pairs of clamping elements clamp two edges of the vibration plate, thereby securing the vibration plate to the first securing member.

8. The electronic device of claim 7, wherein each pair of clamping elements comprises a first portion and a second portion which wraps the first portion; the two second portions are secured to the two ends of the slot; the two first portions clamp two edges of the vibration plate.

9. The electronic device of claim 7, wherein the second securing member defines at least one through hole each communicating with the slot and facing one speaker assembly; each urging element is inserted through one through hole and the cover of the speaker assembly, and applies the pushing force to the speaker via the mounting member.

10. The electronic device of claim 6, wherein the second securing member defines at least one receiving space; each speaker assembly is secured in one receiving space, with the buffer protruding out of the receiving space; the second securing member comprises a plurality of elongated magnets along and fixed to four edges of the second securing member; the first securing member comprises a plurality of elongated magnets along and fixed to four edges of the first securing member; the vibration plate is located between the first securing member and the second securing member and surrounded by the magnets, and is secured between the first securing member and the second securing member by a magnetic attractive force between the magnets; the buffer protruding out of the receiving space is in tight contact with the vibration plate.

11. The electronic device of claim 10, wherein each urging element is inserted through the receiving space and the cover of one speaker assembly, to apply a pushing force to the speaker via the mounting member.

12. An electronic device comprising:
a hollow housing;
a first securing member fixedly received in the housing;
a vibration plate received in the housing and secured to the first securing member; and
at least one speaker assembly each fixedly received in the housing, and comprising a speaker and a buffer secured to the speaker, a side of each buffer away from the speaker being in contact with the vibration plate.

13. An electronic device comprising:
a hollow housing comprising a bottom cover and a top cover secured to the bottom cover, the top cover defining a display window;
a display screen received in the housing and secured to the top cover, to allow contents displayed on the display screen viewable from the display window; and
at least one speaker assembly each received in the housing, secured to the bottom cover, and comprising a speaker and a buffer secured to the speaker, a side of each buffer away from the speaker being in contact with the display screen.

14. An electronic device comprising:
a housing defining a substantially enclosed interior space;
a first securing member;
a second securing member secured to the first securing member;
a vibration plate substantially received within the enclosed interior space; and
at least one speaker assembly, each speaker assembly having a speaker and a buffer, the buffer including a first side and a second side opposite the first side;
wherein, the vibration plate is secured to the first securing member; and
wherein, the at least one speaker assembly is secured to the second securing member with the buffer secured to the speaker and positioned with the first buffer side facing the speaker and the second buffer side being in contact with the vibration plate.
